(19) United States
(12) Patent Application Publication
(10) Pub. No.: US 2009/0115711 A1
(43) Pub. Date: May 7, 2009

(54) LIQUID CRYSTAL DISPLAY DEVICE

(75) Inventor: Munetoshi Ueyama, Mie (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/066,716

(22) PCT Filed: Apr. 19, 2006
(86) PCT No.: PCT/JP2006/308178

§ 371 Date: Mar. 13, 2008

(30) Foreign Application Priority Data
Sep. 14, 2005 (JP) 2005-266423

(51) Int. Cl. G09G 3/36

(52) U.S. Cl. 345/87

(57) ABSTRACT

A liquid crystal display device can achieve reduction in the thickness thereof and the size of its frame while reducing color unevenness even when single color LEDs are incorporated as a light source for a backlight. The liquid crystal display device includes a liquid crystal panel, a light guide plate disposed at the back of the liquid crystal panel and a light source arranged at one side of the light guide plate; the light from the light source illuminates the liquid crystal panel through the light guide plate. The light source is composed of a red, green and blue LEDs emitting red, green and blue light, respectively; the LEDs are arranged along the one side of the light guide plate, and are arranged in three rows in the direction of the thickness of the light guide plate. The colors of the light emitted from the LEDs arranged side by side in the direction of the thickness of the light guide plate are different from each other.

### BACKGROUND OF THE INVENTION

1. Field of the Invention

The present invention relates to a liquid crystal display device for use as a display screen in a thin-screen television set, a personal computer, a mobile telephone, a portable information device or the like, and more particularly to a backlight incorporated in such a liquid crystal display device.

2. Description of the Related Art

In general, as a backlight that illuminates, from behind, a liquid crystal panel serving as a display screen in a liquid crystal display device, one of the following two backlights is used: a so-called direct-type backlight where a light source is arranged at the back of a liquid crystal panel; and a so-called edge-light type backlight where a light source is arranged at one side (or on the opposite sides) of a frame surrounding the liquid crystal panel. As a light source for these backlights, a cold cathode fluorescent tube (CCFT) or a light emitting diode (hereinafter also called “LED”) is used. In particular, with respect to the LED, a white LED emitting white light is used so that the white light therefrom is used as the backlight; or three types of LEDs, namely, red, green and blue LEDs, which emit red, green and blue light, respectively, are used so that the mixed light obtained by mixing the red, green and blue light from the LEDs is used as the backlight.

Since a cold cathode fluorescent tube requires a high voltage for driving it and thus consumes high electric power, care should be taken in disposing of a cold cathode fluorescent tube containing toxic mercury and other inconveniences arising therefrom, LEDs are today more widely used as light sources for backlights than cold cathode fluorescent tubes in terms of environmental protection. With respect to the LEDs, single color LEDs (red, green and blue LEDs) tend to be used more widely than white LEDs. This is because a wider range of colors are reproduced from the mixed light produced by the single color LEDs than from the white light by the white LEDs. Since a cold cathode fluorescent tube emits white light, it achieves about the same degree of color reproduction as the white LEDs.

Hereinafter, a liquid crystal display device incorporating single color LEDs as a light source for a backlight will be described based on the above-described advantage of single color LEDs.

A description will first be given of a conventional liquid crystal display device incorporating a direct-type backlight (for example, see JP-UM-A-S63-043177). In this liquid crystal display device, single color LEDs serving as a light source for a backlight are arranged at the back of a liquid crystal panel. Specifically, red, green and blue LEDs are evenly spaced on the whole area opposite the display area of the liquid crystal panel, and colors of adjacent LEDs are different from each other. Red, green and blue light emitted from the LEDs mixes to produce mixed light, and reaches and illuminates the liquid crystal panel. Optical sheets are disposed between the liquid crystal panel and the LEDs.

Immediately above the individual LEDs, however, the red, green and blue light from the LEDs does not mix well and reaches the liquid crystal panel, and this locally causes unevenness in the mixed color of red, green and blue. This leads to degradation in the display quality of the liquid crystal display device. For this reason, in practice, in order for this color unevenness to be reduced, a sufficient distance is provided between the liquid crystal panel and the LEDs, and in addition, a large number of diffusing plates and diffusing sheets are stacked and arranged between the liquid crystal panel and the LEDs so that the red, green and blue light mixes well before reaching the liquid crystal panel.

A description will now be given of a conventional liquid crystal display device incorporating an edge-light type backlight with reference to FIGS. 16 to 18 (for example, see JP-A-2002-341797). FIG. 16 is a cross-sectional view showing an example of a conventional liquid crystal display device incorporating an edge-light type backlight. FIG. 17 is a cross-sectional view showing another example of the liquid crystal display device. FIG. 18 is a plan view showing a light source for a backlight in the liquid crystal display device.

In the liquid crystal display devices shown in FIGS. 16 and 17, a light guide plate 2 is disposed at the back of a liquid crystal panel 1 and opposite to the display area of the liquid crystal panel 1; at one side of the light guide plate 2, single color LEDs (red, green and blue LEDs 3R, 3G and 3B) serving as a light source for a backlight are arranged to attach to a reflective plate 4 having a U-shape in cross section. Specifically, as shown in FIG. 18, on the inner surface of the reflective plate 4, the red, green and blue LEDs 3R, 3G and 3B are aligned in turn repeatedly and linearly along the one side of the light guide plate 2, and colors of adjacent LEDs are different from each other. In FIG. 18, the red, green and blue LEDs 3R, 3G and 3B are schematically represented by squares, circles and rhombuses, respectively.

A reflective sheet 5 is placed on the back of the light guide plate 2, and a back plate 6 forming part of the outer shape of the liquid crystal display device is attached to the back of the reflective sheet 5 and the reflective plate 4. The liquid crystal panel 1 is supported by a frame 7 that forms a frame portion surrounding the liquid crystal panel 1 and a supporting member 8; the frame 7 and the supporting member 8 are fixed to the back plate 6. The reflective plate 4 is retained by the supporting member 8 and the back plate 6, and is accommodated in one side portion of the frame portion along with the LEDs 3R, 3G and 3B.

The red, green and blue light emitted from the LEDs 3R, 3G and 3B is diffusely reflected through the light guide plate 2, and reaches and evenly illuminates the liquid crystal panel 1. In this case, however, in the vicinity of the side of the liquid crystal panel 1 near the LEDs 3R, 3G and 3B, the red, green and blue light from the LEDs 3R, 3G and 3B does not mix well and reaches the liquid crystal panel 1, and this locally causes unevenness in the mixed color of red, green and blue. For this reason, in practice, in order for this color unevenness to be reduced, a sufficient distance is provided, as shown in FIG. 16, between the liquid crystal panel 1 and the light guide plate 2 or a sufficient distance is provided, as shown in FIG. 17, between the LEDs 3R, 3G and 3B and the light guide plate 2 so that the red, green and blue light mixes well before reaching the liquid crystal panel 1. In the case of FIG. 16, in the space V1 between the liquid crystal panel 1 and the light guide plate 2, the red, green and blue light mixes well to produce mixed light; in the case of FIG. 17, in the space V2 between the LEDs 3R, 3G and 3B and the light guide plate 2, the red, green and blue light mixes well to produce mixed light.

Between the liquid crystal panel 1 and the light guide plate 2, optical sheets 9 are disposed behind the liquid crystal panel 1. In the liquid crystal display device shown in FIG. 16, a diffusing plate 10 is disposed on the optical sheets 9.

Although liquid crystal display devices today are required to be slim and have a small frame, in the above-described conventional liquid crystal display device incorporating single color LEDs as a light source for a backlight, it is difficult to achieve reduction in the thickness thereod and the size of its frame. This is because of the following reasons. In a conventional liquid crystal display device having a direct-type backlight, in order for color unevenness to be reduced, the thickness of the device as a whole is inevitably increased so that a sufficient distance is provided between the liquid crystal panel and the LEDs. Similarly, in a conventional liquid crystal display device having an edge-light type backlight, in a case where a sufficient distance is provided between the liquid crystal panel and the light guide plate, the thickness of the device as a whole (in the vertical direction of FIG. 16) is inevitably increased; in a case where a sufficient distance is provided between the LEDs and the light guide plate, the width of the frame portion housing the LEDs (in the horizontal direction of FIG. 17) is inevitably increased.

### SUMMARY OF THE INVENTION

In order to overcome the problems described above, preferred embodiments of the present invention provide a liquid crystal display device that achieves reduction in the thickness thereof and the size of its frame while reducing color unevenness even when single color LEDs are incorporated therein as a light source for a backlight.

According to a preferred embodiment of the present invention, a liquid crystal display device includes a liquid crystal panel, a light guide plate disposed at the back of the liquid crystal panel and a light source arranged at one side of the light guide plate. In this liquid crystal display device, the light from the light source illuminates the liquid crystal panel through the light guide plate, the light source includes red, green and blue light emitting diodes emitting red, green and blue light, respectively, the light emitting diodes are arranged along the one side of the light guide plate and are arranged in a plurality of rows in the direction of the thickness of the light guide plate and the colors of the light emitted from the light emitting diodes arranged side by side in the direction of the thickness of the light guide plate are different from each other.

In this way, the red, green and blue light from the light emitting diodes, respectively, mixes effectively at least before exiting from the light guide plate, and thereby produces mixed light without fail before reaching the liquid crystal panel. Thus, unlike conventional liquid crystal display devices, it is possible to reduce color unevenness in the vicinity of the side of the liquid crystal panel near the light emitting diodes as well as in other areas without the need of a light-mixing space between the liquid crystal panel and the light guide plate and without the need of a light-mixing space between the light emitting diodes and the light guide plate.

With the liquid crystal display device according to preferred embodiments of the present invention, it is possible to achieve reduction in the thickness thereof and the size of its frame while reducing color unevenness even when single color LEDs are incorporated therein as a light source for a backlight.

Other features, elements, processes, steps, characteristics and advantages of the present invention will become more apparent from the following detailed description of preferred embodiments of the present invention with reference to the attached drawings.

### BRIEF DESCRIPTION OF DRAWINGS

FIG. 1 is a cross-sectional view showing the liquid crystal display device of a first preferred embodiment of the present invention.

FIG. 2 is a plan view showing a light source for a backlight in the liquid crystal display device of the first preferred embodiment of the present invention.

FIG. 3 is a plan view showing a variation of the light source for the backlight in the liquid crystal display device of the first preferred embodiment of the present invention.

FIG. 4 is a plan view showing another variation of the light source for the backlight in the liquid crystal display device of the first preferred embodiment of the present invention.

FIG. 5 is a cross-sectional view showing the variation of the light source for the backlight in the liquid crystal display device of the first preferred embodiment of the present invention.

FIG. 6 is a cross-sectional view showing the liquid crystal display device of a second preferred embodiment of the present invention.

FIG. 7 is a plan view showing a light source for a backlight in the liquid crystal display device of the second preferred embodiment of the present invention.

FIG. 8 is a plan view showing a variation of the light source for the backlight in liquid crystal display device of the second preferred embodiment of the present invention.

FIG. 9 is a plan view showing another variation of the light source for the backlight in the liquid crystal display device of the second preferred embodiment of the present invention.

FIG. 10 is a cross-sectional view showing the variation of the light source for the backlight in the liquid crystal display device of the second preferred embodiment of the present invention.

FIG. 11 is a cross-sectional view showing the liquid crystal display device of a third preferred embodiment of the present invention.

FIG. 12 is a plan view showing a light source for a backlight in the liquid crystal display device of the third preferred embodiment of the present invention.

FIG. 13 is a plan view showing a variation of the light source for the backlight in the liquid crystal display device of the third preferred embodiment of the present invention.

FIG. 14 is a plan view showing another variation of the light source for the backlight in the liquid crystal display device of the third preferred embodiment of the present invention.

FIG. 15 is a cross-sectional view showing the variation of the light source for the backlight in the liquid crystal display device of the third preferred embodiment of the present invention.

FIG. 16 is a cross-sectional view showing an example of a conventional liquid crystal display device.

FIG. 17 is a cross-sectional view showing another example of a conventional liquid crystal display device.

FIG. 18 is a plan view showing a light source for a backlight in the conventional liquid crystal display.

### DETAILED DESCRIPTION OF THE PREFERRED EMBODIMENTS

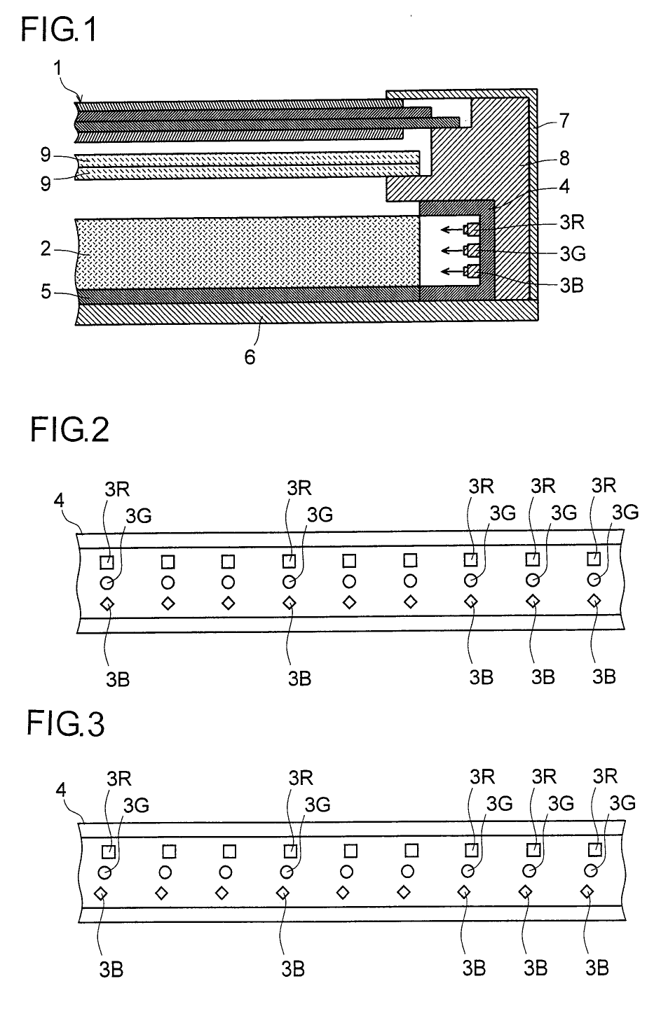

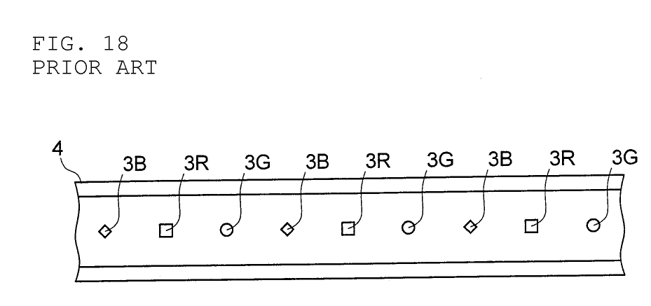

Hereinafter, preferred embodiments of the present invention will be described in detail with reference to the accompanying drawings. A description will first be given of the liquid crystal display device of a first preferred embodiment of the present invention. FIG. 1 is a cross-sectional view showing the liquid crystal display device of the first preferred embodiment; FIG. 2 is a plan view showing a light source for a backlight in the liquid crystal display device. In these figures, such parts as have the same names and functions as in FIGS. 16 to 18 are identified with common reference numerals, and the same description will not be repeated as appropriate. This also applies to second and third preferred embodiments which will be described later.

In the liquid crystal display device of this preferred embodiment, an edge-light type backlight is provided, a substantially rectangular light guide plate 2 is disposed at the back of a substantially rectangular liquid crystal display panel 1 and at one side of the light guide plate 2, single color LEDs (red, green and blue LEDs 3R, 3G and 3B) serving as a light source for the backlight are arranged to attach to a reflective plate 4. Specifically, on the inner surface of the reflective plate 4, the red, green and blue LEDs 3R, 3G and 3B are arranged, along the one side of the light guide plate 2, in three rows arranged side by side in the direction of the thickness of the light guide plate 2 (in the vertical direction of FIGS. 1 and 2). In particular, in this preferred embodiment, the rows of the different-colored LEDs, that is, the rows of the red, green and blue LEDs 3R, 3G and 3B are arranged one color after another, from the side of the light guide plate 2 near the liquid crystal panel 1, in the direction of the thickness of the light guide plate 2; these rows disposed in this order are arranged along the light guide plate 2. In the red, green and blue LEDs 3R, 3G and 3B arranged in the direction of the thickness of the light guide plate 2, the center of the line connecting the red LED 3R in the uppermost row, that is, in the first row and the blue LED 3B in the lowermost row, that is, in the third row substantially coincides with the center of the thickness of the light guide plate 2.

Preferably, the wavelengths of the peaks of the line spectra of the light emitted by the red, green and blue LEDs 3R, 3G and 3B fall within the ranges of 610-670 nm (red LED 3R) and 510-570 nm (green LED 3G) and 410-470 nm (blue LED 3B), respectively, for example.

The order in which the LEDs 3R, 3G and 3B are arranged in the direction of the thickness of the light guide plate 2 may be any one of the following orders, provided that the different-colored LEDs are arranged one color after another: the red LEDs 3R, blue LEDs 3B and green LEDs 3G; the green LEDs 3G, blue LEDs 3B and red LEDs 3R; the green LEDs 3G, red LEDs 3R and blue LEDs 3B; the blue LEDs 3B, red LEDs 3R and green LEDs 3G; and the blue LEDs 3B, green LEDs 3G and red LEDs 3R.

In this way, the red, green and blue light emitted from the LEDs 3R, 3G and 3B is diffusely reflected through the light guide plate 2, and reaches and evenly illuminates the liquid crystal panel 1. In this case, the red, green and blue light from the LEDs 3R, 3G and 3B arranged side by side in the direction of the thickness of the light guide plate 2 mixes effectively at least before exiting from the light guide plate 2, and thereby produces mixed light without fail before reaching the liquid crystal panel 1. Thus, unlike the conventional liquid crystal panel, it is possible to reduce color unevenness in the vicinity of the side of the liquid crystal panel 1 near the LEDs 3R, 3G and 3B as well as in other areas without the need of the color-mixing space V1 (see FIG. 16) between the liquid crystal panel 1 and the light guide plate 2 and without the need of the color-mixing space V2 (see FIG. 17) between the LEDs 3R, 3G and 3B and the light guide plate 2. That is, it is possible to achieve reduction in the thickness of and the frame size of a liquid crystal display device while reducing color unevenness even when single color LEDs are incorporated therein as a light source for a backlight.

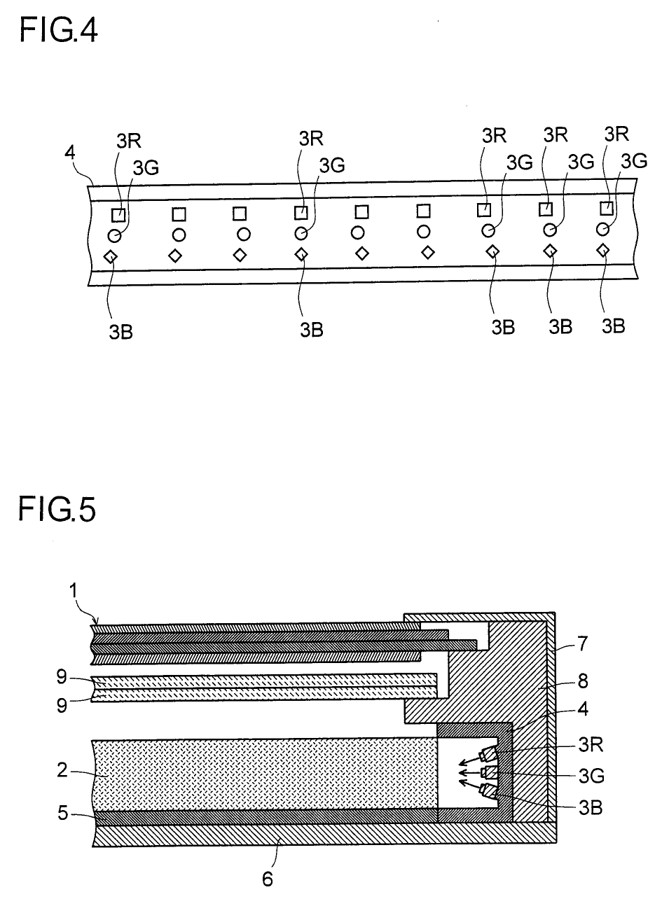

In this preferred embodiment, as shown in FIG. 2, the LEDs 3R, 3G and 3B arranged side by side in the direction of the thickness of the light guide plate 2 are all aligned accurately, as seen in the direction of the thickness of the light guide plate 2, without being displaced from each other along the one side of the light guide plate 2 (in the horizontal direction of FIG. 2). As shown in FIG. 3, however, the LEDs 3R, 3G and 3B may be slightly displaced from each other along the one side of the light guide plate 2 so as to overlap each other. Needless to say, as shown in FIG. 4, some of the LEDs 3R, 3G and 3B may be all aligned accurately and the others may be overlapped.

When the LEDs 3R, 3G and 3B arranged side by side in the direction of the thickness of the light guide plate 2 are attached to the reflective plate 4 so as to slant at different angles from each other, the red, green and blue light from the LEDs 3R, 3G and 3B is mixed more easily. This serves to reduce color unevenness effectively. For example, it is preferable that, as shown in FIG. 5, the LEDs 3R, 3G and 3B arranged side by side in the direction of the thickness of the light guide plate 2 be attached so as to emit light toward the center of the thickness of the one side of the light guide plate 2.

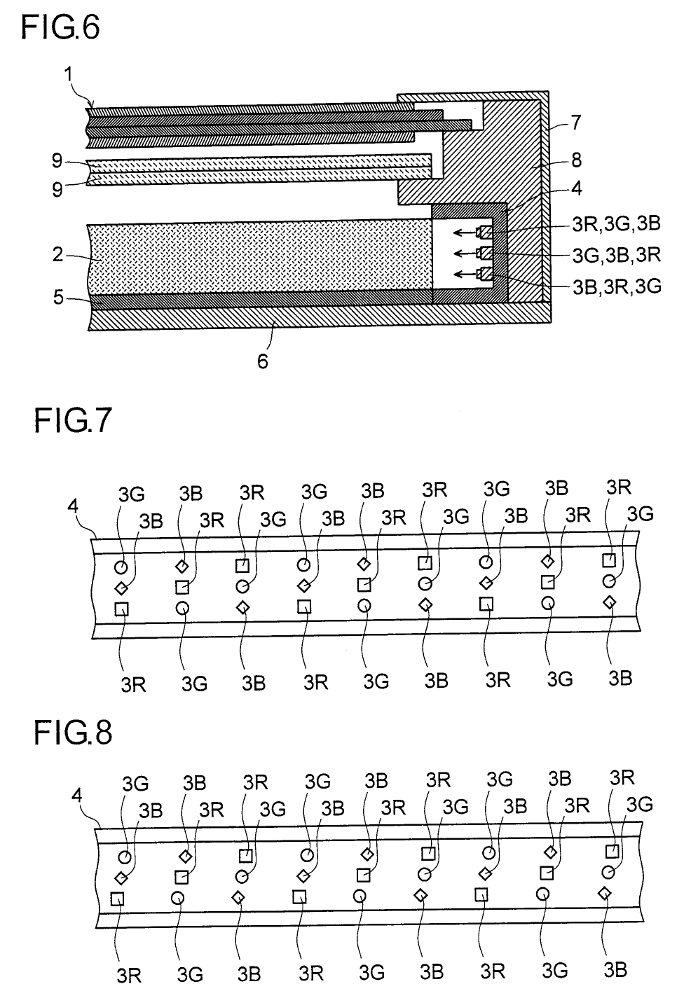

A description will now be given of a second preferred embodiment of the present invention. FIG. 6 is a cross-sectional view showing the liquid crystal display device of the second preferred embodiment; FIG. 7 is a plan view showing a light source for a backlight in the liquid crystal display device. The second preferred embodiment is characterized in that the order in which the red, green and blue LEDs 3R, 3G and 3B are arranged in the first preferred embodiment is modified.

On the inner surface of the reflective plate 4, the red, green and blue LEDs 3R, 3G and 3B are arranged, along the one side of the light guide plate 2, in three rows arranged side by side in the direction (in the vertical direction of FIGS. 6 and 7) of the thickness of the light guide plate 2. In particular, in this preferred embodiment, the different-colored LEDs, that is, the red, green and blue LEDs 3R, 3G and 3B are repeatedly and linearly aligned one color after another along the one side of the light guide plate 2; the different-colored LEDs are adjacently arranged one color after another in the direction of the thickness of the light guide plate 2. For example, in one column, the red, green and blue LEDs 3R, 3G and 3B are aligned in turn, from the side of the light guide plate 2 near the liquid crystal panel 1, in the direction of the thickness of the light guide plate 2, in the next column, the green, blue and red LEDs 3G, 3B and 3R are aligned in turn, in the further next column, the blue, red and green LEDs 3B, 3B and 3R are aligned in turn and so on. With respect to the red, green and blue LEDs 3G, 3B and 3R aligned in the direction of the thickness of the light guide plate 2, the center of the line connecting a set of the LEDs 3R, 3G and 3B in the uppermost row, that is, in the first row and a set of the LEDs 3R, 3G and 3B in the lowermost row, that is, in the third row substantially coincides with the center of the thickness of the light guide plate 2.

In this way, the red, green and blue light from the LEDs 3R, 3G and 3B arranged side by side in the direction of the thickness of the light guide plate 2 mixes effectively at least before exiting from the light guide plate 2, and thus the same benefit as in the first preferred embodiment is obtained. Moreover, in this preferred embodiment, the different-colored LEDs are adjacently aligned one color after another in the direction along the light guide plate 2, and thus the light therefrom is more evenly mixed in this direction. Consequently, a further enhancement in the display quality of the liquid crystal display device is achieved.

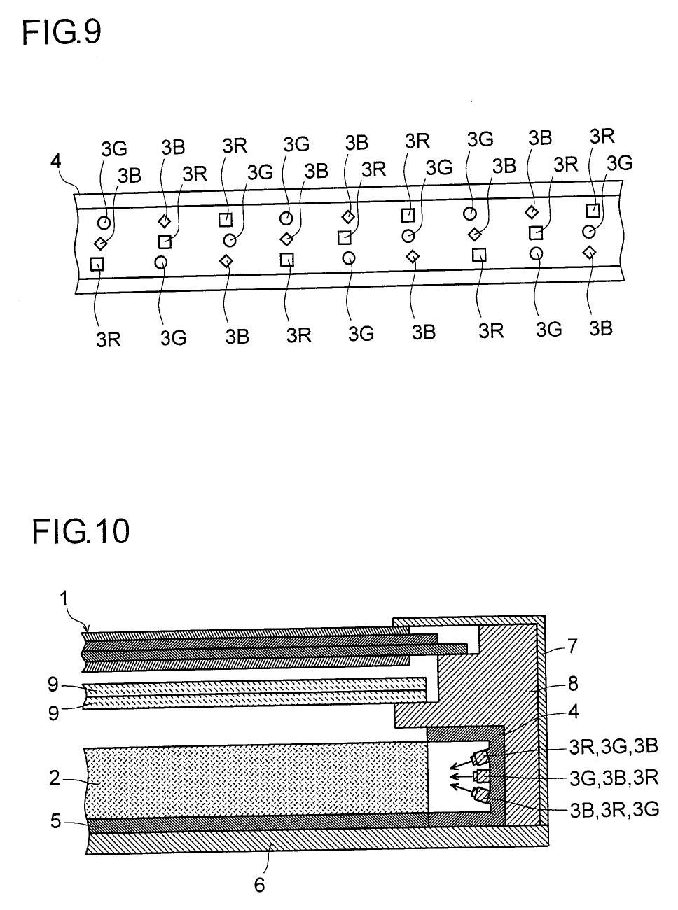

In this preferred embodiment, as in the case of FIG. 2 of the first preferred embodiment, the LEDs 3R, 3G and 3B arranged side by side in the direction of the thickness of the light guide plate 2 are all aligned accurately as shown in FIG. 7, as seen in the direction of the thickness of the light guide plate 2. As in the case of FIG. 3 of the first preferred embodiment, however, the LEDs 3R, 3G and 3B may be displaced as shown in FIG. 8 so as to overlap each other. Needless to say, as in the case of FIG. 4 of the first preferred embodiment, some of the LEDs 3R, 3G and 3B may be all aligned accurately and the others may be overlapped, as shown in FIG. 9.

As in the first preferred embodiment, the LEDs 3R, 3G and 3B arranged side by side in the direction of the thickness of the light guide plate 2 may be attached to the reflective plate 4 so as to slant at different angles from each other. For example, it is preferable that, as shown in FIG. 10, the LEDs 3R, 3G and 3B arranged side by side in the direction of the thickness of the light guide plate 2 be attached so as to emit light toward the center of the thickness of the one side of the light guide plate 2.

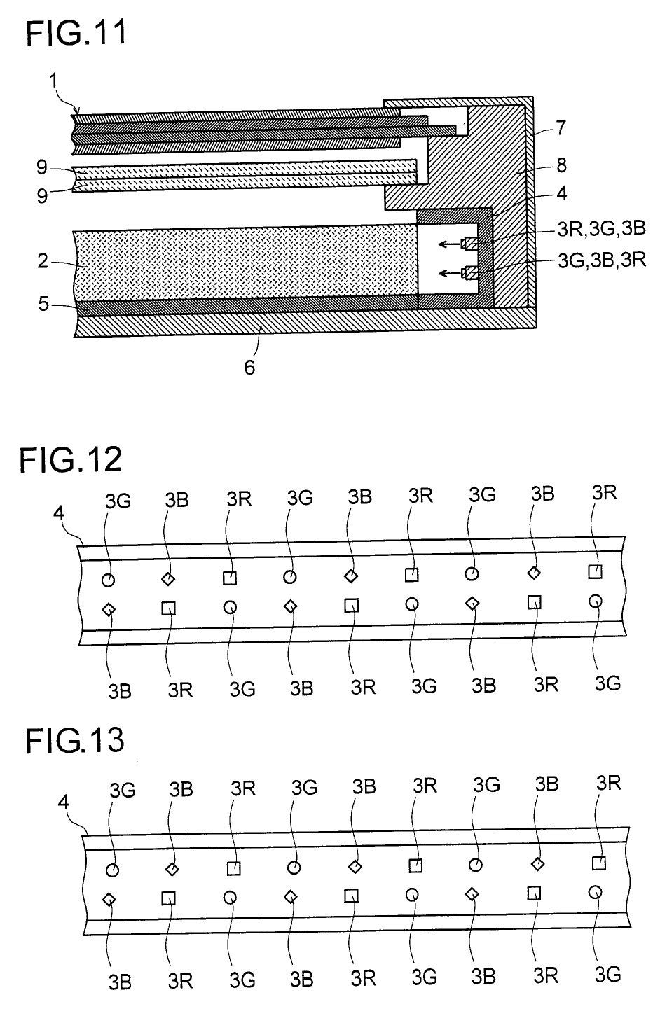

A description will now be given of a third preferred embodiment of the present invention. FIG. 11 is a cross-sectional view showing the liquid crystal display device of the third preferred embodiment; FIG. 12 is a plan view showing a light source for a backlight in the liquid crystal display device. The third preferred embodiment is characterized in that the arrangement of the LEDs is modified according to how the red, green and blue LEDs 3R, 3G and 3B are arranged in the second preferred embodiment.

On the inner surface of the reflective plate 4, the red, green and blue LEDs 3R, 3G and 3B are arranged, along the one side of the light guide plate 2, in two rows arranged side by side in the direction (in the vertical direction of FIGS. 11 and 12) of the thickness of the light guide plate 2. In particular, in this preferred embodiment, the different-colored LEDs, that is, the red, green and blue LEDs 3R, 3G and 3B are repeatedly and linearly aligned one color after another along the one side of the light guide plate 2; the different-colored LEDs are adjacently arranged one color after another in the direction of the thickness of the light guide plate 2. For example, in one column, the red and green LEDs 3R and 3G are aligned in turn, from the side of the light guide plate 2 near the liquid crystal panel 1, in the direction of the thickness of the light guide plate 2, in the next column, the green and blue LEDs 3G and 3B are aligned in turn, in the further next column, the blue and red LEDs 3B and 3B are aligned in turn and so on. With respect to the red, green and blue LEDs 3G, 3B and 3R aligned in the direction of the thickness of the light guide plate 2, the center of the line connecting a set of the LEDs 3R, 3G and 3B in the uppermost row, that is, in the first row and a set of the LEDs 3R, 3G and 3B in the lowermost row, that is, in the third row substantially coincides with the center of the thickness of the light guide plate 2.

In this way, the different-colored light from the LEDs 3R, 3G and 3B arranged side by side in the direction of the thickness of the light guide plate 2 mixes effectively at least before exiting from the light guide plate 2, and thus substantially the same benefit as in the first preferred embodiment is obtained. Since the space in which to arrange the LEDs 3R, 3G and 3B in two rows in the direction of the thickness of the light guide plate 2 is only required in this preferred embodiment, a further reduction in the thickness of the liquid crystal display device is anticipated as compared with the first and second preferred embodiments.

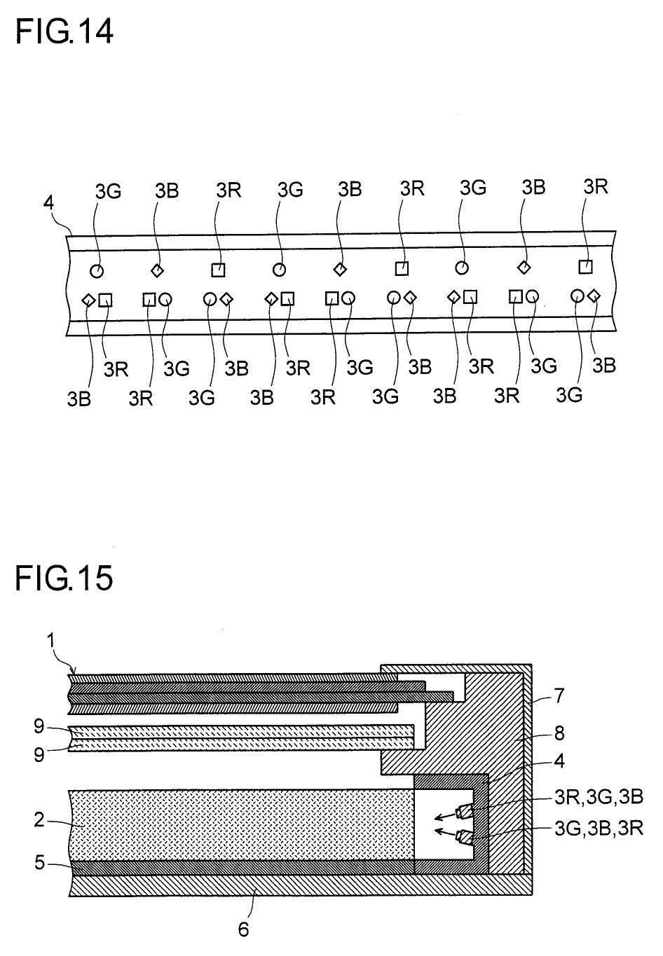

In this preferred embodiment, as in the case of FIG. 2 of the first preferred embodiment and as in the case of FIG. 7 of the second preferred embodiment, the LEDs 3R, 3G and 3B arranged side by side in the direction of the thickness of the light guide plate 2 are all aligned accurately as shown in FIG. 12, as seen in the direction of the thickness of the light guide plate 2. However, as in the case of FIG. 3 of the first preferred embodiment and as in the case of FIG. 8 of the second preferred embodiment, the LEDs 3R, 3G and 3B may be arranged as shown in FIG. 13 so as to overlap each other. Needless to say, as in the case of FIG. 4 of the first preferred embodiment and as in the case of FIG. 9 of the second preferred embodiment, some of the LEDs 3R, 3G and 3B may be all aligned accurately and the others may be overlapped. For example, as shown in FIG. 14, one of the LEDs 3R, 3G and 3B in the first row may overlap with two of the LEDs 3R, 3G and 3B in the second row.

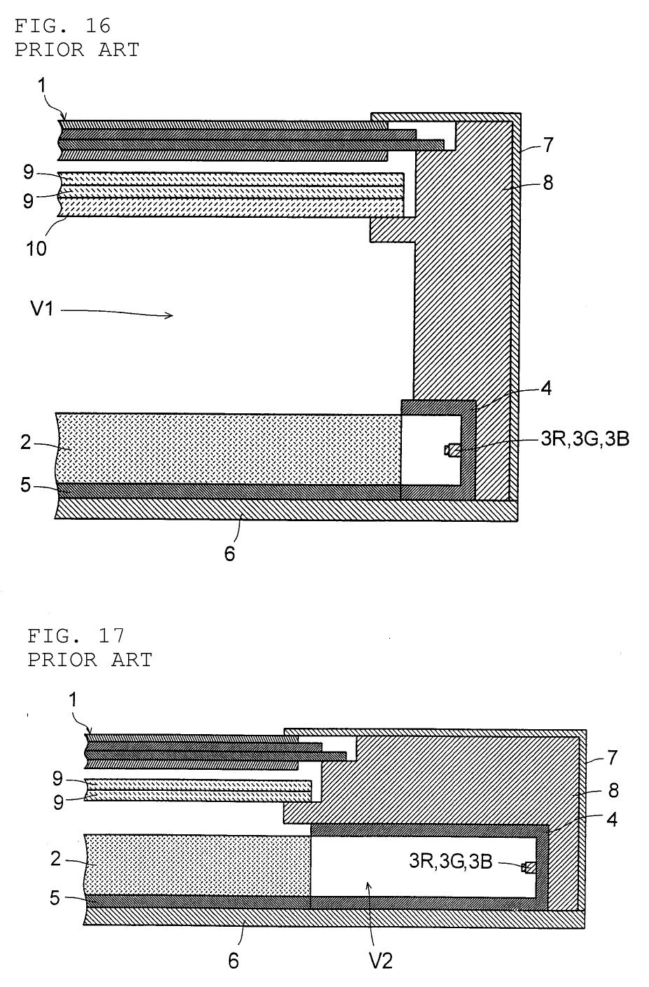

As in the first and second preferred embodiments, the LEDs 3R, 3G and 3B arranged side by side in the direction of the thickness of the light guide plate 2 may be attached to the reflective plate 4 so as to slant at different angles from each other. For example, it is preferable that, as shown in FIG. 15, the LEDs 3R, 3G and 3B arranged side by side in the direction of the thickness of the light guide plate 2 be attached so as to emit light toward the center of the thickness of the one side of the light guide plate 2.

The present invention is not limited to the preferred embodiments described above, and many modifications and variations are possible without departing from the spirit of the present invention. For example, although the preferred embodiments described above deal with cases where the single color LEDs (the red, green and blue LEDs 3R, 3G and 3B) serving as the light source for the backlight are arranged along the one side of the light guide plate 2, and are arranged in two or three rows in the direction of the thickness of the light guide plate 2, they may be arranged in equal to or more than four rows. With respect to types of single color LEDs, cyan, magenta and yellow LEDs emitting cyan, magenta and yellow light, respectively, may be used.

The position where the light source for the backlight including the LEDs 3R, 3G and 3B is arranged is not limited to only one side portion of the frame portion surrounding the liquid crystal panel 1, that is, one side of the light guide plate 2. The light source for the backlight may be arranged at any two, any three or all four of the sides of the light guide plate 2. The light source may also be arranged at the opposite short sides of the light guide plate 2.

The present invention is useful for a liquid crystal display device incorporating single LEDs as a light source for a backlight.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-10. (canceled)

11: A liquid crystal display device comprising a light source arranged at one side of a light guide plate disposed at a back of a liquid crystal panel, wherein a plurality of types of light emitting diodes emitting light having different wavelengths are included in the light source, the light emitting diodes are arranged along the one side of the light guide plate and are arranged in a plurality of rows in a direction of thickness of the light guide plate and the light emitting diodes emitting light having different wavelengths at least overlap each other along the direction of the thickness of the light guide plate.

12: The liquid crystal display device of claim 11, wherein the light emitting diodes include a red light emitting diode, a green light emitting diode and a blue light emitting diode.

13: The liquid crystal display device of claim 11, wherein, in the light emitting diodes arranged in the direction of the thickness of the light guide plate, a center of a line connecting a light emitting diode in an uppermost row and a light emitting diode in a lowermost row substantially coincides with a center of the thickness of the light guide plate.

14: The liquid crystal display device of claim 11, wherein the light sources are arranged at any two sides of the light guide plate.

15: The liquid crystal display device of claim 11, wherein the light sources are arranged at any three sides of the light guide plate.

16: The liquid crystal display device of claim 11, wherein the light sources are arranged at four sides of the light guide plate.

17: The liquid crystal display device of claim 11, wherein the light sources are arranged at opposite short sides of the light guide plate.

18: The liquid crystal display device of claim 11, wherein colors of light emitted from the light emitting diodes arranged side by side along the one side of the light guide plate are different from each other.

19: The liquid crystal display device of claim 11, wherein the light emitting diodes arranged side by side in the direction of the thickness of the light guide plate slant at different angles from each other.

20: The liquid crystal display device of claim 19, wherein the light emitting diodes
arranged side by side in the direction of the thickness of the light guide plate emit light toward a center of the one side of the light guide plate.
